(19) United States
(12) Patent Application Publication
(10) Pub. No.: US 2011/0052366 A1
(43) Pub. Date: Mar. 3, 2011

(54) Device And Method For Secure Control Of A Manipulator

(75) Inventors: Uwe Bonin, Friedberg (DE); Stefan Sturm, Sulzdorf (DE)

(73) Assignee: KUKA ROBOTER GMBH, Augsburg (DE)

(21) Appl. No.: 12/868,184

(22) Filed: Aug. 25, 2010

(30) Foreign Application Priority Data
Aug. 25, 2009 (DE) 10 2009 038 721.8

(51) Int. Cl. B25J 13/00

(52) U.S. Cl. 414/800; 901/2

(57) ABSTRACT

A method according to the invention for controlling a manipulator, in particular a robot (1), includes the following steps:
controlling of the manipulator by means of an operating device (4) of a first safety level, which is connected to a control device (2) of the manipulator, and
monitoring of a permissible state by means of a protective device (3, 3.1, 3.2) of a second, higher safety level, which is connected to the control device of the manipulator, wherein the manipulator executes an action prescribed by the operating device only as long as the protective device is communicating a permissible state to the control device.

The present invention relates to a method and an arrangement for safe manual control of a manipulator, in particular a robot such as for example an industrial robot.

Because of the potential for endangering operating personnel, industrial robots must be operated using reliable technology. For example, the relevant standard ISO 10218-1:2006 stipulates that a manual programming device must have a three-position enabling pushbutton. Such pushbuttons, which are known for example from DE 100 23 199 A1 and DE 299 23 980 U1, differentiate between a non-activated position, a panic position with fully-pressed pushbutton, and a middle position. The robot moves only when the middle position is detected using reliable technology and is reported to the controller of the robot.

Such reliable detection, evaluation and transmission of control commands, as described for example in DE 44 32 768 C2 and WO 99/29474 A2, is expensive because of the necessary redundancy or diversity, proven operational effectiveness and the like.

The object of the present invention is to improve the safe control of a manipulator.

This problem is solved by a method having the features of Claim 1. Claim 6 protects an arrangement, Claims 12 and 13 a computer program or computer program product, in particular a data medium or storage medium, for carrying out a method according to Claim 1. The subordinate claims relate to advantageous refinements.

The invention is based on the idea of separating the safety and control functionalities. This makes it possible on the one hand to employ an operating device of a lower safety level to control the manipulator manually, since said device only needs to realize the control functionality, and thus can be of simpler, more economical, more mobile and/or more compact design. On the other hand, to guarantee the safety functionality a protective device of a higher safely level can be used, which is already available anyway for automatic operation of the manipulator. For example, if a protective device such as a protective fence with monitored protective door, preferably provided for automatic operation of the manipulator, ensures that there is no operator within a forbidden protected zone, according to the invention the manipulator can also be controlled using non-secure technology by means of an operating device of a low safety level.

Correspondingly, according to the invention the manipulator is controlled by means of an operating device of a first safety level, which is connected to a control device of the manipulator.

In this case the operating device can be for example a stationary or mobile personal computer (“PC”) or a hand-held device such as for example a so-called personal digital assistant (“PDA”), a mobile telephone or the like, and because of the low safety requirement can be designed with non-secure technology.

The operating device can be hard-wired to the control device, in particular via a network, or may be connected wirelessly, preferably using electromagnetic radiation such as radio or optical or infrared signals.

Controlling refers in particular to inputting target positions and/or target position changes, for example for axes of the manipulator or position and/or orientation of a reference point or coordinate system fixed in relation to the manipulator, such as the TCP (tool center point), tool movements and/or activations and the like, where in the preferred online teaching the manipulator executes control commands directly and/or they are stored. In this respect, controlling means in particular direct movement of the robot using corresponding control commands. Control commands can be entered for example via keys, a joystick, a mouse and/or a touch screen of the operating device.

The control software, for example a path interpolator, can be implemented in the operating and/or control device, so that in a preferred embodiment the operating device is used only for inputting and transmitting control commands. The operating device can also have a display, for example for displaying inputs and/or visualizing input parameters and/or other parameters.

According to the invention, a protective device of a second, higher safety level, which is connected to the control device of the manipulator, monitors a permissible state. A permissible state can exist in particular when there is no person within a forbidden protected zone. Then no personal injury can occur even if there is a malfunction of the non-secure operating device.

This can be guaranteed for example by a protective fence with one or more monitored safety doors surrounding the forbidden protected zone. Similarly, the protected zone can also be monitored, for example optically, so that entry or presence of persons therein can be detected. In these cases the protective device does not communicate a permissible state to the control device if an operator is within the forbidden protected zone.

The protective device can likewise remove a release signal which indicates a permissible state and/or transmit a disturbance signal which indicates a non-permissible state, in order to not communicate a permissible state to the control device. This too can be done via a hard-wired connection, in particular over a network, or by wireless transmission, as explained above.

In addition or as an alternative to monitoring whether there is a person in a non-permissible protected zone, the manipulator itself can also be monitored, for example by reliably detecting its joint positions and/or positions of one or more of its components or reference points or coordinate systems fixed in relation to the manipulator, and comparing them to permissible value ranges.

A safety level can correspond for example to a safety category according to a relevant standard. At the same time, a higher safety level, in particular the second safety level, can correspond to a reliable technology, and sufficient established operational effectiveness, failure safety and the like can be guaranteed for example by means of appropriate redundancy or diversity, for example through multi-channel protective devices and secure data transmission to and data interpretation in the control device. Correspondingly, a lower safety level, in particular the first safety level, can be implemented using non-secure standard technology. Even technologies that do not satisfy any safety requirements can fulfill a low or first safety level in the meaning of the present invention, where in a preferred embodiment even the first safety level fulfills certain (minimum) safety requirements, which are however preferably lower than those of the reliable technology.

As explained above, the invention is based on the realization that the increased safety demands that have been placed heretofore on operating device for controlling manipulators can be dispensed with if safety is guaranteed by a separate protective device, preferably one that is present anyway for example for automatic operation, if said device ensures that the operator of the operating device remains outside of the forbidden protected area.

Correspondingly, according to the invention the manipulator performs all or at least certain ones of the actions specified by the operating device only if the protective device communicates a permissible state to the control device. In particular, it can be sufficient to prevent motions of the manipulator and/or tool motions and/or activities when the protective device is not communicating a permissible state to the control device.

To this end the control device can for example switch off the operating device, ignore control commands of the operating device, or delay their execution until release is given by the protective device.

Similarly, all actions of the manipulator can also be suppressed as long as the protective device is not communicating a permissible state to the control device, or only motions in non-exceptional axes such as are executed, while dangerous axes, for example carousel, rocker and/or arm axes are deactivated. In addition or alternatively, in a preferred embodiment actions, in particular motions, are not suppressed until after the manipulator has been transformed into a secure state, when the protective device is no longer communicating a permissible state to the control device.

Preferably, as long as the protective device is not communicating a permissible state to the control device there is also a display on the operating device, in particular a display of the non-permissible state.

In particular, in order to utilize already existing protective devices such as a protective fence with protective door for the automatic operation of an industrial robot, the control device for controlling the manipulator can be placed by means of the operating device in a particular operating mode, in which for example motions of the manipulator are only executed as long as the protective device is active, i.e., is communicating a permissible state or is not communicating a non-permissible state. The changeover to this operating mode can be accomplished for example by activating the control device, the operating device, by connecting the control and operating devices, manually or when inputting a control command into the operating device.

In this case in particular, the manipulator can also be controlled by means of a selected one of a plurality of operating devices. Preferably there is then assurance through reciprocal communication among the operating devices, dominant signal transmission, or by the control device, that always only one operating device is active or enables the inputting of control commands to the control device.

In order to also offer the operator who is safely controlling the manipulator according to the invention through a non-secure operating device the possibility to react to problems not recognized by the protective device, in a preferred embodiment an emergency stop input device of a higher safety level, in particular one using reliable technology, is connected to the control device of the manipulator, it being preferred to situate said emergency stop input device in the vicinity of the non-secure operating device, in particular within reach of the operator of the operating device. Such an emergency stop input device can be situated for example as a standardized emergency off switch simply, compactly and conveniently on or near a PC, PDA or the like.

The operating device of the first safety level, like previously employed operating devices using reliable technology, can have an enabling device. The latter can include in particular a pushbutton or a key combination of a keyboard of the operating device. Since it is not used for protecting persons, this enabling device, in contrast to the existing art, advantageously is not subject to any increased safety requirements.

In addition to or alternatively to one or more additional operating devices of a lower, in particular a first safety level, one or more additional operating devices of a higher, in particular a second safety level may be provided. In particular to control the manipulator when the protective device is deactivated, for example when there is an operator within the protected zone, a manual programming device or the like using secure technology can be used. The control system executes the actions specified by this secure operating device even if the protective device is not communicating a permissible state to the control device, for example by selecting an appropriate operating mode of the control device and deactivating or ignoring the non-secure operating device.

Additional advantages and features result from the subordinate claims and the exemplary embodiments. To this end the sole FIGURE shows the following, partially in schematic form:

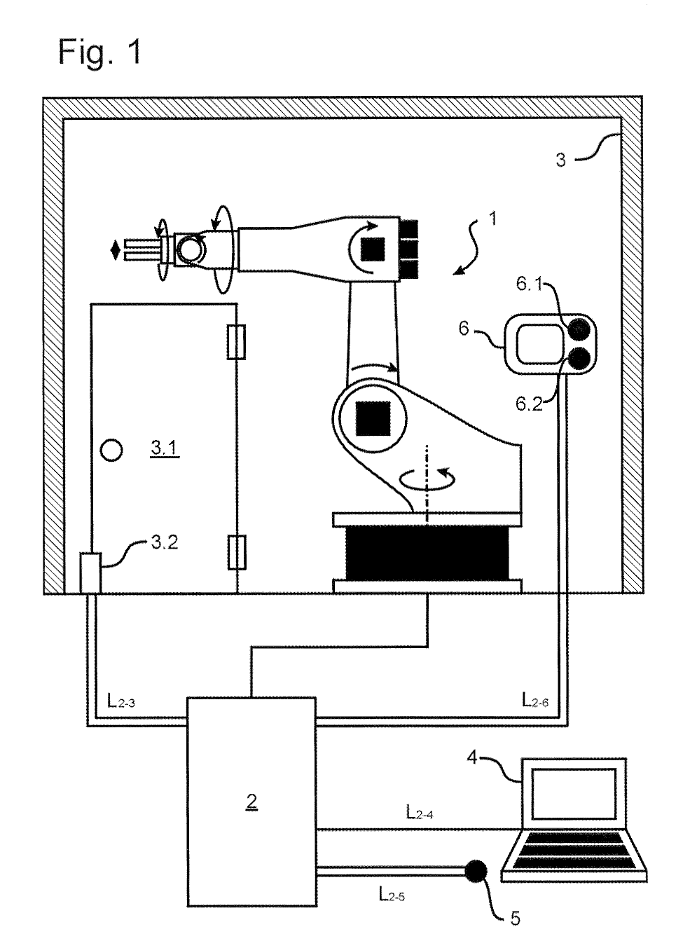

FIG. 1: a control system for a robot according to an embodiment of the present invention.

FIG. 1 shows in cross section a six-axis industrial robot 1 having a control cabinet 2. Robot 1 is only allowed to move within a working area bounded by a protective fence 3 in which no persons are allowed to be present during automatic operation, and which thus defines a prohibited protected zone.

To this end it has a protective door 3.1, which is monitored through a closing contact 3.2. To guarantee safety of personnel, the protective device with protective fence 3, protective door 3.1 and closing contact 3.2 uses secure technology. In particular, closing contact 3.2 is connected to control cabinet 2 using secure technology through the multi-channel redundant conductor L₂₋₃ indicated in FIG. 1, and accordingly has a second, high safety level, for example category 3.

For controlling robot 1, in particular for inputting travel commands in joint or world coordinates, a standard PC 4 is provided. The latter is connected via a simple network, indicated in FIG. 1 in single-channel form by conductor L₂₋₄, to control cabinet 2, which interprets and processes the control commands entered via the keyboard of PC 4 and actuates the drives of robot 1 accordingly. The input data are visualized on the screen of PC 1 [Translator's note: This should apparently be 4], for example by depicting the robot in the virtual working space and/or its joint angles. The standard PC 4, connected by a single channel to control cabinet 2, is thus an operating device using non-secure technology, of a first, low safety level, for example category 1 or lower.

In order to ensure safety of personnel from problems not detected by the protective device, within reach next to the PC 4 a standard emergency off switch 5 (indicated in multi-channel form in FIG. 1 by conductor L₂₋₄) is connected to control cabinet 2, and thus forms an emergency off input device of an equally high or higher safety level than protective device 3-3.2.

In order to be able to also control the robot reliably within the protected zone, a conventional manual programming device 6 with an emergency off switch 6.1 and an enabling pushbutton 6.2 can be connected in addition through multi-channel conductor L₂₋₆ to control cabinet 2 using secure technology.

Control over the manipulator can be turned over either to the PC 4 or to the manual programming device 6, if present, by a user action. If control is turned over to the manual programming device 6, the control system 2 of the robot ignores inputs from the PC 4.

Conversely, in an operating mode for controlling the manipulator by means of operating device 4, in which control device 2 is placed by switching the control system over, the control system executes only motions specified by the PC 4 as long as closing contact 3.2 reports a closed protective door 3.1 or does not report an open protective door 3.1 to control device 2, thereby guaranteeing that no person is entering the protected zone defined by protective fence 3. If other problems arise, for example intrusion into the protected zone through a hole in protective fence 3, the operator can shut down the robot reliably by operating the emergency off button 5 situated in quickly accessible proximity.

Thus the robot can be controlled inexpensively and yet reliably through a standard PC 4, which uses non-secure technology and is connected to control cabinet 2, as a result of using the protective device 3, 3.1, 3.2 provided for automatic operation.

### REFERENCE LABELS

1 robot
2 control cabinet
3 protective fence
3.1 protective door
3.2 closing contact
4 standard PC (operating device)
5 emergency off switch
6 manual programming device
6.1 emergency off switch
6.2 enabling pushbutton
L₂₋ₓ conductor (one- or two-channel)

1-13. (canceled)

14. A method for controlling a robot, wherein movement of the robot is controlled by a control device, the method comprising:
communicating operating commands to the control device from an operating device having a first safety level;
monitoring operation of the robot with a protective device to determine whether a permissible state of operation is present, the protective device having a second safety level higher than the first safety level; and
executing commands received by the control device from the operating device if the protective device is indicating a permissible state is present.

15. The method of claim 14, wherein the protective device indicates a permissible state is present by generating a signal to the control device associated with the presence or absence of the permissible state.

16. The method of claim 14, wherein the protective device indicates a permissible state is present by ceasing to generate a signal to the control device associated with the presence or absence of the permissible state.

17. The method of claim 14, wherein the permissible state is associated with absence of an operator from a protected zone.

18. The method of claim 14, further comprising setting the operating device to a particular operating mode.

19. The method of claim 14, wherein the robot is configured to be controlled by a plurality of operating devices, the method further comprising:
selecting one of the plurality of operating devices, and
communicating the operating commands to the control device from the selected one of the plurality of operating devices.

20. The method of claim 14, further comprising:
executing some commands received by the control device from the operating device even if the protective device is not indicating a permissible state is present.

21. The method of claim 14, wherein communicating operating commands to the control device comprises wirelessly transmitting the operating commands.

22. A system for controlling a robot, comprising:
a control device configured to control movement of the robot;
an operating device operatively coupled to the control device for communicating commands thereto, the operating device being configured to operate at a first safety level; and
a protective device operatively coupled to the control device, the protective device being configured to
(a) operate at a second safety level higher than the first safety level,
(b) monitor a permissible state of operation of the robot, and
(c) indicate to the control device whether a permissible state of operation of the robot is present;
wherein the control device is configured to execute commands received from the operating device if the protective device is indicating a permissible state is present.

23. The system of claim 22, wherein the protective device is configured to generate a signal to the control device, the signal being associated with the presence or absence of the permissible state.

24. The system of claim 22, wherein the protective device is configured to cease generation of a signal to the control device, the signal being associated with the presence or absence of the permissible state.

25. The system of claim 22, further comprising:
an emergency stop input device operatively coupled to the control device and having a safety level higher than the first safety level.

26. The system of claim 22, wherein the operating device comprises an actuating device for communicating commands to the control device.

27. The system of claim 26, wherein the actuating device is a push button or a key combination of a keyboard of the operating device.

28. The system of claim 22, further comprising:
at least a second operating device operatively coupled to the control device and configured to operate at a safety level lower than the second safety level.

29. The system of claim 22, further comprising:
at least a second operating device operatively coupled to the control device and configured to operate at a safety level higher than the first safety level.

30. The system of claim 22, wherein the protective device includes a fence.

31. The system of claim 30, wherein the protective device includes a door providing access through the fence, and a closing contact actuated upon opening or closing of the door.

32. The system of claim 22, wherein the protective device includes an optical apparatus for detecting a state of a protected space.

33. The system of claim 22, wherein the control device is configured to execute some commands received from the operating device even if the protective device does not indicate a permissible state is present.
